(19) United States
(12) Patent Application Publication
(10) Pub. No.: US 2022/0389208 A1
(43) Pub. Date: Dec. 8, 2022

(54) GOLF CLUB GRIP AND GOLF CLUB

(71) Applicant: Sumitomo Rubber Industries, Ltd., Kobe-shi (JP)

(72) Inventors: Sho GOJI, Kobe-shi (JP); Kazuyoshi SHIGA, Kobe-shi (JP)

(73) Assignee: Sumitomo Rubber Industries, Ltd., Kobe-shi (JP)

(21) Appl. No.: 17/829,691

(22) Filed: Jun. 1, 2022

(30) Foreign Application Priority Data
Jun. 2, 2021 (JP) 2021-093015

(51) Int. Cl. C08L 35/04; A63B 53/14; A63B 60/08; C08L 93/04; C08L 35/08

(52) U.S. Cl. CPC C08L 35/04; A63B 53/14; A63B 60/08; C08L 93/04; C08L 35/08; C08L 2666/26

(57) ABSTRACT

An object of the present invention is to provide a golf club grip having high tensile strength in the outer layer and little entrainment of air between the outer layer and the inner layer. The present invention provides a golf club grip comprising a cylindrical portion composed of a cylindrical inner layer and a cylindrical outer layer covering the inner layer, wherein a ratio (E′₂₃/E′₆₀) of a storage modulus (E′₂₃) at 23° C. of the outer layer to a storage modulus (E′₆₀) at 60° C. of the outer layer, measured with a dynamic viscoelasticity measuring apparatus under measuring conditions of an oscillation frequency: 10 Hz, a strain amplitude: 0.05%, and a tensile mode, ranges from 1.20 to 1.32.

### FIELD OF THE INVENTION

The present invention relates to a golf club grip.

### DESCRIPTION OF THE RELATED ART

As a grip attached to a golf club, a rubber grip is widely used. As such rubber grips, a golf club grip having an acrylonitrile-butadiene based rubber as a base rubber and having improved tensile strength or abrasion resistance has been proposed. For example, JP No. 6041829 B and JP No. 2017-113388 A disclose such grips.

### SUMMARY OF THE INVENTION

It has been proposed to use a material having excellent tensile strength in an outer layer (surface layer) of a golf grip. However, if the material having excellent tensile strength is contained in a rubber composition, the non-crosslinked molded product tends to have an increased shrinking rate. Thus, if the non-crosslinked rubber composition is molded into a sheet shape, a problem that the surface easily becomes uneven occurs. Then, if the rubber composition containing such material having excellent tensile strength is used to prepare the outer layer of the grip, air bubbles remain when laminating the outer layer on the inner layer. The air bubbles cause problems like molding failure or initial destruction of the obtained grip.

The present invention has been made in view of the above circumstances, and an object of the present invention is to provide a golf club grip having high tensile strength in the outer layer and reduced air bubbles between the outer layer and the inner layer.

The present invention that has solved the above problem provides a golf club grip comprising a cylindrical portion composed of a cylindrical inner layer and a cylindrical outer layer covering the inner layer, wherein a ratio (E′₂₃/E′₆₀) of a storage modulus (E′23) at the temperature of 23° C. of the outer layer to a storage modulus (E′60) at the temperature of 60° C. of the outer layer, measured with a dynamic viscoelasticity measuring apparatus under measuring conditions of an oscillation frequency: 10 Hz, a strain amplitude: 0.05%, and a tensile mode, ranges from 1.20 to 1.32. If the ratio (E′₂₃/E′₆₀) ranges from 1.20 to 1.32, the shrinking rate of the non-crosslinked molded product can be lowered. Thus, air bubbles can be reduced when laminating the outer layer on the inner layer and occurrence of molding failure or initial destruction of the obtained grip can be suppressed.

According to the present invention, a golf club grip having high tensile strength in the outer layer and reduced air bubbles between the outer layer and the inner layer is obtained.

### BRIEF DESCRIPTION OF THE DRAWINGS

FIG. 1 is a perspective view showing one example of a golf club grip;

FIG. 2 is a schematic cross-sectional view showing one example of a golf club grip; and

FIG. 3 is a perspective view showing one example of a golf club.

### DESCRIPTION OF THE PREFERRED EMBODIMENT

The present invention provides a golf club grip comprising a cylindrical portion composed of a cylindrical inner layer and a cylindrical outer layer covering the inner layer, wherein a ratio (E′₂₃/E′₆₀) of a storage modulus (E′₂₃) at the temperature of 23° C. of the outer layer to a storage modulus (E′₆₀) at the temperature of 60° C. of the outer layer, measured with a dynamic viscoelasticity measuring apparatus under measuring conditions of an oscillation frequency: 10 Hz, a strain amplitude: 0.05%, and a tensile mode, ranges from 1.20 to 1.32.

The temperature of 23° C. which is the measuring temperature of the storage modulus is a temperature condition under which the molded product is stored, and the temperature of 60° C. is a temperature condition under which the rubber composition is processed into a sheet shape. Thus, if the ratio (E′₂₃/E′₆₀) of the storage modulus (E′₂₃) at the temperature of 23° C. to the storage modulus (E′₆₀) at the temperature of 60° C. is kept within the range from 1.20 to 1.32, the shrinking rate after the processing can be lowered. If the ratio (E′₂₃/E′₆₀) is 1.20 or more, the rubber composition has good processibility and the residual stress during the processing can be lowered, thus deformation after the processing can be lowered. In addition, if the ratio (E′₂₃/E′₆₀) is 1.32 or less, the rubber composition has less change between the storage modulus at the processing temperature and the storage modulus at the room temperature, thus deformation after the processing can be lowered.

The golf club grip comprises a cylindrical portion composed of a cylindrical inner layer and a cylindrical outer layer covering the inner layer. The cylindrical portion may be a dual layered construction composed of one inner layer and one outer layer, or a triple layered construction having two inner layers and one outer layer.

The ratio (E′₂₃/E′₆₀) of the storage modulus (E′₂₃) at the temperature of 23° C. of the outer layer to the storage modulus (E′₆₀) at the temperature of 60° C. of the outer layer, measured with a dynamic viscoelasticity measuring apparatus under measuring conditions of an oscillation frequency: 10 Hz, a strain amplitude: 0.05%, and a tensile mode, is 1.20 or more, preferably 1.23 or more, more preferably 1.25 or more, and is 1.32 or less, preferably 1.30 or less, more preferably 1.28 or less. If the ratio (E′₂₃/E′₆₀) is 1.23 or more, the rubber deforms at the temperature of 60° C. more easily, the residual stress can be further lowered, and if the ratio (E′₂₃/E′₆₀) is 1.30 or less, the stress change during cooling to the room temperature (23° C.) after the processing can be further suppressed.

The storage modulus (E′₂₃) at the temperature of 23° C. of the outer layer, measured with a dynamic viscoelasticity measuring apparatus under measuring conditions of an oscillation frequency of 10 Hz, a strain amplitude of 0.05%, and a tensile mode, is preferably 2.0 MPa or more, more preferably 2.5 MPa or more, and even more preferably 3.0 MPa or more, and is preferably 4.2 MPa or less, more preferably 3.7 MPa or less, and even more preferably 3.4 MPa or less. If the storage modulus (E′₂₃) is 2.0 MPa or more, the rubber composition has further enhanced processibility, and if the storage modulus (E′₂₃) is 4.2 MPa or less, the stress occurring during the deformation of the molded product after the processing is lower.

The storage modulus (E′₆₀) at the temperature of 60° C. of the outer layer, measured with a dynamic viscoelasticity measuring apparatus under measuring conditions of an oscillation frequency of 10 Hz, a strain amplitude of 0.05%, and a tensile mode, is preferably 1.5 MPa or more, more preferably 1.8 MPa or more, and even more preferably 2.0 MPa or more, and is preferably 3.7 MPa or less, more preferably 3.5 MPa or less, and even more preferably 3.2 MPa or less. If the storage modulus (E′₆₀) is 1.5 MPa or more, the rubber composition has further enhanced processibility, and if the storage modulus (E′₆₀) is 3.7 MPa or less, the stress occurring during the deformation of the molded product after the processing is lower.

The loss tangent (tan δ) at the temperature of 60° C. of the outer layer, measured with a dynamic viscoelasticity measuring apparatus under measuring conditions of an oscillation frequency of 10 Hz, a strain amplitude of 0.05%, and a tensile mode, is preferably 0.138 or more, more preferably 0.142 or more, and even more preferably 0.146 or more. If the loss tangent (tan δ) is 0.138 or more, the stress occurring during the deformation of the molded product after the processing is lower.

The tensile strength at break (Tb) of the outer layer is preferably 20 MPa or more, more preferably 21 MPa or more, and even more preferably 22 MPa or more, and is preferably 30 MPa or less, more preferably 29 MPa or less, and even more preferably 28 MPa or less. If the tensile strength at break is 20 MPa or more, the grip has further enhanced abrasion resistance, and if the tensile strength at break is 30 MPa or less, the grip has better feeling.

It is preferable that the whole outer layer has the ratio (E′₂₃/E′₆₀) falling within the above numerical range, however, the outer layer may have a portion having the ratio (E′₂₃/E′₆₀) falling outside the above numerical range. In this case, the area percentage of the portion having the ratio (E′₂₃/E′₆₀) falling within the above numerical range in the area 100% of the outer layer is preferably 50% or more, more preferably 70% or more, and even more preferably 90% or more.

The properties of the outer layer can be controlled by adjusting the materials or amounts of the materials in the rubber composition constituting the outer layer. Examples of the outer layer rubber composition constituting the outer layer include a rubber composition containing (A) a base rubber, (B) a thermoplastic resin, and (C) a crosslinking agent.

### (A) Base Rubber

The amount of (A) the base rubber in the outer layer rubber composition is preferably 50 mass % or more, more preferably 55 mass % or more, and even more preferably 60 mass % or more. Examples of (A) the base rubber include a natural rubber (NR), an ethylene-propylene-diene rubber (EPDM), a butyl rubber (IIR), an acrylonitrile-butadiene rubber (NBR), a hydrogenated acrylonitrile-butadiene rubber (HNBR), a carboxy-modified acrylonitrile-butadiene rubber (XNBR), a butadiene rubber (BR), a styrene-butadiene rubber (SBR), a polyurethane rubber (PU), an isoprene rubber (IR), a chloroprene rubber (CR), and an ethylene-propylene rubber (EPM). These base rubbers may be used solely, or two or more of them may be used in combination.

(A) The base rubber preferably includes the acrylonitrile-butadiene based rubber. As the acrylonitrile-butadiene based rubber, at least one member selected from the group consisting of the acrylonitrile-butadiene rubber (NBR), the carboxy-modified acrylonitrile-butadiene rubber (XNBR), the hydrogenated acrylonitrile-butadiene rubber (HNBR), and the carboxy-modified hydrogenated acrylonitrile-butadiene rubber (HXNBR) is preferable. The XNBR is a copolymer of a monomer having a carboxy group, acrylonitrile and butadiene. The HNBR is a hydrogenated product of an acrylonitrile-butadiene rubber. The HXNBR is a hydrogenated product of a copolymer of a monomer having a carboxy group, acrylonitrile and butadiene.

The amount of the acrylonitrile-butadiene based rubber in (A) the base rubber is preferably 50 mass % or more, more preferably 60 mass % or more, and even more preferably 70 mass % or more. In addition, (A) the base rubber of the rubber composition also preferably consists of the acrylonitrile-butadiene based rubber.

The amount of the acrylonitrile in the NBR, XNBR, HNBR and HXNBR is preferably 15 mass % or more, more preferably 18 mass % or more, and even more preferably 21 mass % or more, and is preferably 50 mass % or less, more preferably 45 mass % or less, and even more preferably 40 mass % or less. If the amount of the acrylonitrile is 15 mass % or more, the abrasion resistance is better, and if the amount of the acrylonitrile is 50 mass % or less, the grip has a better touch feeling in a cold region or in winter.

The amount of the double bond in the HNBR and HXNBR is preferably 0.09 mmol/g or more, more preferably 0.2 mmol/g or more, and is preferably 2.5 mmol/g or less, more preferably 2.0 mmol/g or less, and even more preferably 1.5 mmol/g or less. If the amount of the double bond is 0.09 mmol/g or more, vulcanization is easily carried out during molding, and the grip has further enhanced tensile strength, and if the amount of the double bond is 2.5 mmol/g or less, the grip has better durability (weather resistance) and tensile strength. The amount of the double bond can be adjusted by the amount of butadiene in the copolymer or the amount of hydrogen added into the copolymer.

Examples of the monomer having the carboxy group in the XNBR and HXNBR include acrylic acid, methacrylic acid, fumaric acid, and maleic acid. The amount of the monomer having the carboxy group in the XNBR and HXNBR is preferably 1.0 mass % or more, more preferably 2.0 mass % or more, and even more preferably 3.5 mass % or more, and is preferably 30 mass % or less, more preferably 25 mass % or less, and even more preferably 20 mass % or less. If the amount of the monomer having the carboxy group is 1.0 mass % or more, the abrasion resistance is better, and if the amount of the monomer having the carboxy group is 30 mass % or less, the grip has a better touch feeling in a cold region or in winter.

The amount of the carboxy group in the XNBR and HXNBR is preferably 1.0 mass % or more, more preferably 2.0 mass % or more, and even more preferably 3.5 mass % or more, and is preferably 30 mass % or less, more preferably 25 mass % or less, and even more preferably 20 mass % or less. If the amount of the carboxy group is 1.0 mass % or more, the abrasion resistance is better, and if the amount of the carboxy group is 30 mass % or less, the grip has a better touch feeling in a cold region or in winter.

(A) The base rubber preferably includes at least one member selected from the group consisting of XNBR, HNBR and HXNBR, particularly preferably HXNBR. In other words, the outer layer preferably contains at least one member selected from the group consisting of the carboxy-modified acrylonitrile-butadiene rubber (XNBR), the hydrogenated acrylonitrile-butadiene rubber (HNBR), and the carboxy-modified hydrogenated acrylonitrile-butadiene rubber (HXNBR), more preferably contains HXNBR. If the outer layer contains at least one of these rubbers as the base rubber, the grip has enhanced abrasion resistance and weather resistance.

The Mooney viscosity (ML₁₊₄ (100° C.)) of the HXNBR is preferably 60 or more, more preferably 64 or more, and even more preferably 68 or more, and is preferably 95 or less, more preferably 90 or less, and even more preferably 85 or less. If the Mooney viscosity (ML₁₊₄ (100° C.)) is 60 or more, the grip has enhanced abrasion resistance, if the Mooney viscosity (ML₁₊₄ (100° C.)) is 95 or less, the rubber composition has better processibility.

### (B) Resin

(B) The resin is a component for lowering the Mooney viscosity of the outer layer rubber composition. Examples of (B) the resin include a rosin ester, an ethylene-vinyl acetate copolymer, a coumarone resin, and a phenolic resin.

The amount of (B) the resin is preferably 5 parts by mass or more, more preferably 8 parts by mass or more, and even more preferably 12 parts by mass or more, and is preferably 45 parts by mass or less, more preferably 42 parts by mass or less, and even more preferably 40 parts by mass or less, with respect to 100 parts by mass of (A) the base rubber. If the amount of (B) the resin is 5 parts by mass or more, the grip has better feeling, and if the amount of (B) the resin is 45 parts by mass or less, the grip has further enhanced abrasion resistance.

The outer layer rubber composition preferably contains (B1) the ethylene-vinyl acetate copolymer and (B2) the rosin ester as (B) the resin. If (B1) the ethylene-vinyl acetate copolymer and (B2) the rosin ester are contained, these components melt during processing and the rubber composition becomes soft, thus the stress during deformation can be lowered.

The amount of the vinyl acetate in (B1) the ethylene-vinyl acetate copolymer is preferably 10 mass % or more, more preferably 12 mass % or more, and even more preferably 15 mass % or more, and is preferably 80 mass % or less, more preferably 75 mass % or less, and even more preferably 70 mass % or less. If the amount of the vinyl acetate is 10 mass % or more, the grip has better feeling, and if the amount of the vinyl acetate is 80 mass % or less, the grip has further enhanced abrasion resistance.

The Mooney viscosity (ML₁₊₄ (100° C.)) of (B1) the ethylene-vinyl acetate copolymer is preferably 20 or more, more preferably 23 or more, and even more preferably 25 or more, and is preferably 50 or less, more preferably 45 or less, and even more preferably 40 or less. If the Mooney viscosity (ML₁₊₄ (100° C.)) is 20 or more, the rubber composition has better processibility, and if the Mooney viscosity (ML₁₊₄ (100° C.)) is 50 or less, the grip has better feeling.

The amount of (B1) the ethylene-vinyl acetate copolymer is preferably 3 parts by mass or more, more preferably 5 parts by mass or more, and even more preferably 8 parts by mass or more, and is preferably 40 parts by mass or less, more preferably 35 parts by mass or less, and even more preferably 30 parts by mass or less, with respect to 100 parts by mass of (A) the base rubber. If the amount of (B1) the ethylene-vinyl acetate copolymer is 3 parts by mass or more, the grip has better feeling, and if the amount of (B1) the ethylene-vinyl acetate copolymer is 40 parts by mass or less, the grip has further enhanced abrasion resistance.

(B2) The rosin ester is an ester compound obtained by a reaction between a rosin and an alcohol. The rosin is a natural resin containing abietic acid, neoabietic acid, palustric acid, pimaric acid, isopimaric acid, and dehydroabietic acid. Examples of the alcohol include a monohydric alcohol such as n-octyl alcohol, 2-ethylhexyl alcohol, decyl alcohol, lauryl alcohol and stearyl alcohol; a dihydric alcohol such as ethylene glycol, diethylene glycol, polyethylene glycol, propylene glycol, dipropylene glycol, polypropylene glycol and neopentyl glycol; a trihydric alcohol such as glycerin and trimethylolpropane; a tetrahydric alcohol such as pentaerythritol and diglycerin; and a hexahydric alcohol such as dipentaerythritol and sorbitol. Among them, the polyhydric alcohol such as the dihydric alcohol or higher alcohol is preferable, and glycerin is more preferable.

The rosin ester includes a hydrogenated rosin ester and a disproportionated rosin ester. The hydrogenated rosin ester and the disproportionated rosin ester are so-called stabilized rosin esters.

The hydrogenated rosin ester is an ester compound having the moiety that is derived from the rosin of the rosin ester and is hydrogenated. The hydrogenated rosin ester may be obtained by a method of hydrogenating the rosin followed by carrying out a reaction between the obtained hydrogenated rosin and an alcohol, or a method of carrying out a reaction between the rosin and an alcohol followed by hydrogenating the obtained rosin ester.

The disproportionated rosin ester is an ester compound having the moiety that is derived from the rosin of the rosin ester and is disproportionated. The disproportionated rosin ester may be obtained by a method of disproportionating the rosin followed by carrying out a reaction between the obtained disproportionated rosin and an alcohol, or a method of carrying out a reaction between the rosin and an alcohol followed by disproportionating the obtained rosin ester.

The acid value of the rosin ester is preferably 2 mgKOH/g or more, more preferably 4 mgKOH/g or more, and even more preferably 6 mgKOH/g or more, and is preferably 200 mgKOH/g or less, more preferably 180 mgKOH/g or less, and even more preferably 160 mgKOH/g or less. If the acid value is 2 mgKOH/g or more, the rosin ester has better compatibility with the acrylonitrile-butadiene based rubber, and if the acid value is 200 mgKOH/g or less, the carboxy group included in the rosin ester nearly does not affect the vulcanization reaction of the base rubber.

The amount of (B2) the rosin ester is preferably 2 parts by mass or more, more preferably 5 parts by mass or more, and even more preferably 7 parts by mass or more, and is preferably 15 parts by mass or less, more preferably 12 parts by mass or less, and even more preferably 10 parts by mass or less, with respect to 100 parts by mass of (A) the base rubber. If the amount of (B2) the rosin ester is 2 parts by mass or more, the rubber composition is softer, and if the amount of (B2) the rosin ester is 15 parts by mass or less, the rubber composition has better processibility.

In the case that the outer layer rubber composition contains (B1) the ethylene-vinyl acetate copolymer and (B2) the rosin ester, the mass ratio (B1/B2) of (B1) the ethylene-vinyl acetate copolymer to (B2) the rosin ester is preferably 0.8 or more, more preferably 1.0 or more, even more preferably 1.2 or more, and mostly preferably 1.5 or more, and is preferably 5.0 or less, more preferably 4.8 or less, and even more preferably 4.5 or less.

In the case that the outer layer rubber composition contains (B1) the ethylene-vinyl acetate copolymer and (B2) the rosin ester, the total amount (B1+B2) of (B1) the ethylene-vinyl acetate copolymer and (B2) the rosin ester is preferably 5 parts by mass or more, more preferably 8 parts by mass or more, and even more preferably 12 parts by mass or more, and is preferably 45 parts by mass or less, more preferably 42 parts by mass or less, and even more preferably 40 parts by mass or less.

The coumarone resin is a resin including a coumarone-based compound as a monomer component. The coumarone resin is preferably a coumarone-indene resin. The coumarone-indene resin is a copolymer including, as a monomer component, a coumarone-based compound and an indene-based compound, in a total amount of 50 mass % or more in all the monomer components. Examples of the coumarone-based compound include coumarone, and methyl coumarone. The amount of the coumarone-based compound in all the monomer components preferably ranges from 1 mass % to 20 mass %. Examples of the indene-based compound include indene, and methyl indene. The amount of the indene-based compound in all the monomer components preferably ranges from 40 mass % to 95 mass %. The coumarone-indene resin may further include other monomer components than the coumarone-based compound and the indene-based compound. Examples of the other monomer components include styrene, vinyl toluene, and dicyclopentadiene.

Examples of the phenolic resin include a condensation product of a phenol-based compound and formaldehyde. Examples of the phenol-based compound include phenol, and m-cresol. In addition, examples of the phenolic resin include a resol obtained by an addition reaction between the phenol-based compound and the formaldehyde in the presence of an alkaline catalyst; and a novolac obtained by a condensation reaction between the phenol-based compound and the formaldehyde in the presence of an acid catalyst. Examples of the phenolic resin further include a rosin phenolic resin obtained by an addition reaction and a thermal polymerization reaction between the phenol-based compound and a rosin in the presence of an acid catalyst.

### (C) Crosslinking Agent

As the crosslinking agent, a sulfur crosslinking agent and an organic peroxide can be used. Examples of the sulfur crosslinking agent include an elemental sulfur and a sulfur donor type compound. Examples of the elemental sulfur include powdery sulfur, precipitated sulfur, colloidal sulfur, and insoluble sulfur. Examples of the sulfur donor type compound include 4,4′-dithiobismorpholine. Examples of the organic peroxide include dicumyl peroxide, α,α′-bis(t-butylperoxy-m-diisopropyl) benzene, 2,5-dimethyl-2,5-di(t-butylperoxy) hexane, and 1,1-bis(t-butylperoxy)-3,3,5-trimethylcyclohexane. The crosslinking agent may be used solely, or two or more of them may be used in combination. As the crosslinking agent, the sulfur crosslinking agent is preferred, and the elemental sulfur is more preferred.

The amount of (C) the crosslinking agent is preferably 0.2 part by mass or more, more preferably 0.4 part by mass or more, and even more preferably 0.6 part by mass or more, and is preferably 4.0 parts by mass or less, more preferably 3.5 parts by mass or less, and even more preferably 3.0 parts by mass or less, with respect to 100 parts by mass of (A) the base rubber.

The outer layer rubber composition preferably further contains a vulcanization accelerator or a vulcanization activator.

### (Vulcanization Accelerator)

Examples of the vulcanization accelerator include thiurams such as tetramethylthiuram disulfide (TMTD), tetrabenzylthiuram disulfide (TBzTD), tetramethylthiuram monosulfide (TMTM), dipentamethylenethiuram tetrasulfide and tetrakis(2-ethylhexyl)thiuram disulfide; guanidines such as diphenylguanidine (DPG); dithiocarbamates such as zinc dimethyldithiocarbamate (ZnPDC), and zinc dibutyldithiocarbamate; thioureas such as trimethylthiourea, and N,N′-diethylthiourea; thiazoles such as mercaptobenzothiazole (MBT), and benzothiazole disulfide; and sulfenamides such as N-cyclohexyl-2-benzothiazolylsulfenamide (CBS), and N-t-butyl-2-benzothiazolylsulfenamide (BBS). These vulcanization accelerators may be used solely, or two or more of them may be used in combination.

The total amount of the vulcanization accelerator is preferably 0.4 part by mass or more, more preferably 0.8 part by mass or more, and even more preferably 1.2 parts by mass or more, and is preferably 9.0 parts by mass or less, more preferably 8.0 parts by mass or less, and even more preferably 7.0 parts by mass or less, with respect to 100 parts by mass of (A) the base rubber.

### (Vulcanization Activator)

Examples of the vulcanization activator include a metal oxide, a metal peroxide, and a fatty acid. Examples of the metal oxide include zinc oxide, magnesium oxide, and lead oxide. Examples of the metal peroxide include zinc peroxide, chrome peroxide, magnesium peroxide, and calcium peroxide. Examples of the fatty acid include stearic acid, oleic acid, and palmitic acid. These vulcanization activators may be used solely, or two or more of them may be used in combination.

The total amount of the vulcanization activator is preferably 0.5 part by mass or more, more preferably 0.6 part by mass or more, and even more preferably 0.7 part by mass or more, and is preferably 10.0 parts by mass or less, more preferably 9.5 parts by mass or less, and even more preferably 9.0 parts by mass or less, with respect to 100 parts by mass of (A) the base rubber.

The outer layer rubber composition may further contain a reinforcing material, an antioxidant, a softening agent, an anti-scorching agent, a coloring agent, or the like, where necessary.

Examples of the reinforcing material include carbon black and silica. The amount of the reinforcing material is preferably 2.0 parts by mass or more, more preferably 3.0 parts by mass or more, and even more preferably 4.0 parts by mass or more, and is preferably 50 parts by mass or less, more preferably 45 parts by mass or less, and even more preferably 40 parts by mass or less, with respect to 100 parts by mass of (A) the base rubber.

Examples of the antioxidant include imidazoles, amines, phenols and thioureas. Examples of the imidazoles include nickel dibutyldithiocarbamate (NDIBC), 2-mercaptobenzimidazole, and zinc salt of 2-mercaptobenzimidazole. Examples of the amines include phenyl-α-naphtylamine. Examples of the phenols include 2,2′-methylene bis(4-methyl-6-t-butylphenol) (MBMBP), and 2,6-di-tert-butyl-4-methylphenol. Examples of the thioureas include tributyl thiourea, and 1,3-bis(dimethylaminopropyl)-2-thiourea. These antioxidants may be used solely, or two or more of them may be used in combination.

The amount of the antioxidant is preferably 0.2 part by mass or more, more preferably 0.3 part by mass or more, and even more preferably 0.4 part by mass or more, and is preferably 5.0 parts by mass or less, more preferably 4.8 parts by mass or less, and even more preferably 4.6 parts by mass or less, with respect to 100 parts by mass of (A) the base rubber.

Examples of the softening agent include a mineral oil and a plasticizer. Examples of the mineral oil include paraffin oil, naphthene oil, and aromatic oil. Examples of the plasticizer include dioctyl phthalate, dibutyl phthalate, dioctyl sebacate, and dioctyl adipate.

Examples of the anti-scorching agent include an organic acid and a nitroso compound. Examples of the organic acid include phthalic anhydride, pyromellitic anhydride, trimellitic anhydride, benzoic acid, salicylic acid, and malic acid. Examples of the nitroso compound include N-nitrosodiphenylamine, N-(cyclohexylthio)phthalimide, sulfonamide derivative, diphenyl urea, bis(tridecyl)pentaerythritol diphosphite, and 2-mercaptobenzimidazole.

The outer layer rubber composition may be prepared by a conventional method. For example, the outer layer rubber composition may be prepared by kneading materials with a kneading machine such as a Banbury mixer, a kneader or an open roll. It is noted that when the outer layer rubber composition contains microballoons which will be described later, other components except the microballoons are preferably kneaded in advance followed by kneading the kneaded product and the microballoons. The material temperature when kneading the kneaded product and the microballoons is preferably set at a temperature lower than the expansion starting temperature of the microballoons.

The outer layer may be a solid layer or a porous layer. If the outer layer is the porous layer, the golf club grip has a light weight. The porous layer is a layer having a plurality of fine pores (voids) formed in the rubber which is the base material. If a plurality of fine pores are formed, the layer has a low apparent density, and thus the golf club grip has a light weight.

Examples of the method producing the porous layer include a balloon foaming method, chemical foaming method, supercritical carbon dioxide injection molding method, salt extraction method, and solvent removing method. In the balloon foaming method, microballoons are allowed to be contained in the rubber composition, and then be expanded by heating to perform foaming. In addition, the expanded microballoons may be blended in the rubber composition, and then the resultant rubber composition is molded. In the chemical foaming method, a foaming agent (such as azodicarbonamide, azobisisobutyronitrile, N,N′-dinitrosopentamethylenetetramine, p-toluenesulfonyl hydrazine, and p-oxybis(benzenesulfohydrazide)) and a foaming auxiliary are allowed to be contained in the rubber composition, and then a gas (such as carbon dioxide gas and nitrogen gas) is generated by a chemical reaction to perform foaming. In the supercritical carbon dioxide injection molding method, the rubber composition is immersed in carbon dioxide being in a supercritical state at a high pressure, the resultant rubber composition is injected at a normal pressure, and carbon dioxide is gasified to perform foaming. In the salt extraction method, a soluble salt (such as boric acid and calcium chloride) is allowed to be contained in the rubber composition, and then the salt is dissolved and extracted after molding to form fine pores. In the solvent removing method, a solvent is allowed to be contained in the rubber composition, and then the solvent is removed after molding to form fine pores.

When the outer layer is a porous layer, a foamed layer formed from the outer layer rubber composition containing a foaming agent is preferred. In particular, a foamed layer formed by the balloon foaming method is preferred. In other words, the outer layer is preferably a foamed layer formed from the outer layer rubber composition containing microballoons. If microballoons are used, the outer layer has a light weight while maintaining the mechanical strength thereof.

As the microballoons, organic microballoons or inorganic microballoons may be used. Examples of the organic microballoons include hollow particles formed from a thermoplastic resin, and resin capsules encapsulating a hydrocarbon having a low boiling point in a shell formed from a thermoplastic resin. Specific examples of the resin capsules include Expancel (registered trademark) manufactured by Akzo Nobel Company, and Matsumoto Microsphere (registered trademark) manufactured by Matsumoto Yushi Seiyaku Co., Ltd. Examples of the inorganic microballoons include hollow glass particles (such as silica balloons and alumina balloons), and hollow ceramic particles.

The volume average particle size of the resin capsule (before expansion) is preferably 5 μm or more, more preferably 6 μm or more, and even more preferably 9 μm or more, and is preferably 90 μm or less, more preferably 70 μm or less, and even more preferably 60 μm or less.

When the outermost layer is produced by the balloon foaming method, the amount of the microballoons in the outer layer rubber composition is preferably 1.0 part by mass or more, more preferably 1.2 parts by mass or more, and even more preferably 1.5 parts by mass or more, and is preferably 10 parts by mass or less, more preferably 8 parts by mass or less, and even more preferably 6 parts by mass or less, with respect to 100 parts by mass of the base rubber. If the amount of the microballoons is 1.0 part by mass or more, foaming can be performed more uniformly at the time of forming the porous layer, and if the amount of the microballoons is 10 parts by mass or less, the porous layer strikes a good balance between the light weight and the mechanical strength.

The material hardness (Shore A hardness) of the outer layer rubber composition is preferably 25 or more, more preferably 28 or more, and even more preferably 30 or more, and is preferably 60 or less, more preferably 55 or less, and even more preferably 50 or less. If the material hardness (Shore A hardness) of the outer layer rubber composition is 25 or more, the outer layer has further enhanced mechanical strength, and if the material hardness (Shore A hardness) of the outer layer rubber composition is 60 or less, the outer layer does not become excessively hard, and thus the grip feeling when holding the grip becomes better.

The Mooney viscosity (ML₁₊₄ (100° C.)) of the outer layer rubber composition is preferably 35 or more, more preferably 37 or more, and even more preferably 39 or more, and is preferably 55 or less, more preferably 53 or less, and even more preferably 50 or less. If the Mooney viscosity (ML₁₊₄ (100° C.)) is 35 or more, the grip has further enhanced abrasion resistance, and if the Mooney viscosity (ML₁₊₄ (100° C.)) is 55 or less, the rubber composition has better processibility.

The material for forming other portions of the golf club grip than the outer layer is not particularly limited. Examples of the material for forming the inner layer include an inner layer rubber composition and a resin composition.

The inner layer rubber composition preferably contains a base rubber and a crosslinking agent. Examples of the base rubber include a natural rubber (NR), an ethylene-propylene-diene rubber (EPDM), a butyl rubber (IIR), an acrylonitrile-butadiene rubber (NBR), a hydrogenated acrylonitrile-butadiene rubber (HNBR), a carboxy-modified acrylonitrile-butadiene rubber (XNBR), a carboxy-modified hydrogenated acrylonitrile-butadiene rubber (HXNBR), a butadiene rubber (BR), a styrene-butadiene rubber (SBR), a polyurethane rubber (PU), an isoprene rubber (IR), a chloroprene rubber (CR), and an ethylene-propylene rubber (EPM). Among them, the base rubber is preferably NR, EPDM, IIR, NBR, HNBR, XNBR, HXNBR, BR, SBR, or PU.

Examples of the crosslinking agent used for the inner layer rubber composition include the same one as those employed in the outer layer rubber composition, and the elemental sulfur is preferable. The inner layer rubber composition preferably further contains a vulcanization accelerator and a vulcanization activator. Examples of these vulcanization accelerator and vulcanization activator include the same one as those employed in the outer layer rubber composition. As the vulcanization accelerator, N-t-butyl-2-benzothiazolylsulfenamide and tetrabenzylthiuram disulfide are preferable. As the vulcanization activator, zinc oxide and stearic acid are preferable.

The inner layer rubber composition may further contain a reinforcing material, an antioxidant, a softening agent, a coloring agent, an anti-scorching agent, or the like, where necessary. Examples of the reinforcing material, antioxidant, and coloring agent include the same one as those employed in the outer layer rubber composition. As the reinforcing material, carbon black or silica is preferable. As the antioxidant, 2,2′-methylene bis(4-methyl-6-t-butylphenol) is preferable.

The inner layer rubber composition may be prepared by a conventional method. For example, the inner layer rubber composition may be prepared by kneading materials with a kneading machine such as a Banbury mixer, a kneader or an open roll. The temperature (material temperature) performing the kneading preferably ranges from 70° C. to 160° C. It is noted that when the inner layer rubber composition contains microballoons, the kneading is preferably performed at a temperature lower than the expansion starting temperature of the microballoons.

The resin composition contains a base resin. Examples of the base resin include a polyurethane resin, a polystyrene resin, a polyethylene resin, a polypropylene resin, an ethylene-vinyl acetate copolymer resin, and a polyethylene terephthalate resin.

The material for forming the inner layer is preferably the inner layer rubber composition, and preferably contains the natural rubber (NR), the ethylene-propylene-diene rubber (EPDM) or the butyl rubber (IIR) as the base rubber. In addition, when the outer layer rubber composition contains the acrylonitrile-butadiene based rubber as (A) the base rubber, the inner layer rubber composition also preferably contains the acrylonitrile-butadiene based rubber as the base rubber. If the inner layer rubber composition contains the acrylonitrile-butadiene based rubber, the adhesion between the inner layer and the outer layer formed from the outer layer rubber composition is enhanced.

The inner layer may be solid or porous. When the inner layer is porous, the inner layer preferably has a foamed construction formed from the inner layer rubber composition containing microballoons. If the microballoons are used, the formed portion has a light weight while maintaining the mechanical strength thereof. Examples of the microballoons include the same one as those employed in the outer layer rubber composition, and the resin capsule encapsulating the hydrocarbon having the low boiling point in the shell formed from the thermoplastic resin is preferable.

The thickness of the cylindrical portion is preferably 0.5 mm or more, more preferably 1.0 mm or more, even more preferably 1.5 mm or more, and is preferably 17.0 mm or less, more preferably 10.0 mm or less, even more preferably 8.0 mm or less. The cylindrical portion may be formed with a fixed thickness along the axis direction, or may be formed with a thickness gradually becoming thicker from the front end toward the back end.

The outer layer and the inner layer may have a uniform thickness, or may have a varied thickness. For example, the outer layer and the inner layer may be formed with a thickness gradually becoming thicker from one end toward another end along the axis direction of the cylindrical grip. The outer layer preferably has a uniform thickness.

When the cylindrical portion has a thickness in a range of from 0.5 mm to 17.0 mm, the thickness of the outer layer is preferably 0.5 mm or more, more preferably 0.6 mm or more, and even more preferably 0.7 mm or more, and is preferably 2.5 mm or less, more preferably 2.3 mm or less, and even more preferably 2.1 mm or less. If the thickness of the outer layer is 0.5 mm or more, the reinforcing effect by the outer layer material becomes greater, and if the thickness of the outer layer is 2.5 mm or less, the inner layer can be relatively thickened and thus the effect of reducing the weight of the grip becomes greater.

The percentage ((thickness of outer layer/thickness of cylindrical portion)×100) of the thickness of the outer layer to the thickness of the cylindrical portion is preferably 0.5% or more, more preferably 1.0% or more, and even more preferably 1.5% or more, and is preferably 99.0% or less, more preferably 98.0% or less, and even more preferably 97.0% or less. If the percentage is 0.5% or more, the reinforcing effect by the outer layer material becomes greater, and if the percentage is 99.0% or less, the inner layer can be relatively thickened and thus the effect of reducing the weight of the grip becomes greater.

The material hardness (Shore A hardness) of the inner layer rubber composition is preferably 30 or more, more preferably 35 or more, and even more preferably 40 or more, and is preferably 60 or less, more preferably 55 or less, and even more preferably 50 or less. If the material hardness (Shore A hardness) of the inner layer rubber composition is 30 or more, the inner layer does not become excessively soft and thus a tightly fixed touch feeling can be obtained when holding the grip, and if the material hardness (Shore A hardness) of the inner layer rubber composition is 60 or less, the inner layer does not become excessively hard and thus the grip feeling when holding the grip becomes better.

Examples of the combination of the outer layer and the inner layer include a combination of a solid outer layer and a solid inner layer, a combination of a solid outer layer and a porous inner layer, and a combination of a porous outer layer and a porous inner layer. Among them, the combination of the solid outer layer and the porous inner layer, and the combination of the porous outer layer and the porous inner layer are preferable. If the inner layer is porous, the inner layer has lowered mechanical strength although the grip has a light weight. However, since the outer layer rubber composition is excellent in the mechanical strength, even if the inner layer is porous, the mechanical strength of the grip can be maintained.

The inner layer is preferably a porous layer, more preferably a foamed layer produced by the balloon foaming method. When the inner layer is produced by the balloon foaming method, the amount of the microballoons in the inner layer composition is preferably 5 parts by mass or more, more preferably 8 parts by mass or more, and even more preferably 12 parts by mass or more, and is preferably 20 parts by mass or less, more preferably 18 parts by mass or less, and even more preferably 15 parts by mass or less, with respect to 100 parts by mass of the base material (base rubber or base resin). If the amount of the microballoons is 5 parts by mass or more, the grip has a lighter weight, and if the amount of the microballoons is 20 parts by mass or less, lowering in the mechanical strength of the inner layer can be suppressed.

In addition, the foaming ratio of the inner layer prepared by the balloon foaming method is preferably 1.2 or more, more preferably 1.5 or more, and even more preferably 1.8 or more, and is preferably 5.0 or less, more preferably 4.5 or less, and even more preferably 4.0 or less. If the foaming ratio is 1.2 or more, the grip has a lighter weight, and if the foaming ratio is 5.0 or less, lowering in the mechanical strength of the inner layer can be suppressed.

The golf club grip may be obtained by molding the outer layer rubber composition in a mold. Examples of the molding method include a press molding method and an injection molding method. In addition, the golf club grip having an inner layer and an outer layer may be obtained, for example, by press molding a laminated product composed of an unvulcanized rubber sheet formed from the outer layer rubber composition and an unvulcanized rubber sheet formed from the inner layer rubber composition in a mold. When the press molding method is adopted, the temperature of the mold preferably ranges from 140° C. to 200° C., the molding time preferably ranges from 5 minutes to 40 minutes, and the molding press preferably ranges from 0.1 MPa to 100 MPa.

Examples of the shape of the golf club grip include a shape having a cylindrical portion for inserting a shaft, and an integrally molded cap portion for covering the opening of the back end of the cylindrical portion. Further, the cylindrical portion has a laminated construction composed of the inner layer and the outer layer.

The cylindrical portion may be formed with a fixed thickness along the axis direction, or may be formed with a thickness gradually becoming thicker from the front end toward the back end. In addition, the cylindrical portion may be formed with a fixed thickness along the diameter direction, or a projecting strip portion (so-called back line) may be formed on a part of the cylindrical portion. Furthermore, grooves may be formed on the surface of the cylindrical portion. Formation of a water film between the hand of the golfer and the grip may be suppressed by the grooves, and thus the grip performance under a wet condition is further enhanced. In addition, in view of the anti-slipping performance and abrasion resistance of the grip, a reinforcing cord may be disposed in the grip.

The mass of the golf club grip is preferably 16 g or more, more preferably 18 g or more, and even more preferably 20 g or more, and is preferably 35 g or less, more preferably 32 g or less, and even more preferably 30 g or less.

### [Golf Club]

The present invention also includes a golf club using the above golf club grip. The golf club comprises a shaft, a head provided on one end of the shaft, and a grip provided on another end of the shaft, wherein the grip is the golf club grip according to the present invention. The shaft can be made of stainless steel or a carbon fiber reinforced resin. Examples of the head include a wood type, a utility type, and an iron type. The material constituting the head is not particularly limited, and examples thereof include titanium, titanium alloy, carbon fiber reinforced plastic, stainless steel, maraging steel and soft iron.

Next, the golf club grip and the golf club will be explained with reference to figures. FIG. 1 is a perspective view showing one example of a golf club grip. A grip 1 has a cylindrical portion 2 for inserting a shaft, and an integrally molded cap portion 3 for covering the opening of the back end of the cylindrical portion.

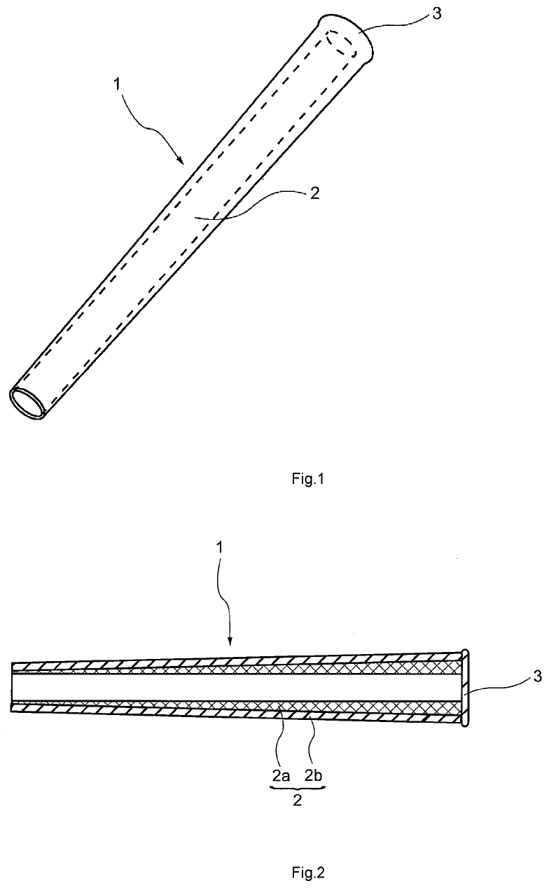

FIG. 2 is a schematic cross-sectional view showing one example of a golf club grip. A cylindrical portion 2 is composed of an inner layer 2a and an outer layer 2b. The outer layer 2b is formed with a uniform thickness throughout the entire region from the front end to the back end. The inner layer 2a is formed with a thickness gradually becoming thicker from the front end toward the back end. In the grip 1 shown in FIG. 2, the cap portion 3 is formed from the same rubber composition as the outer layer 2b.

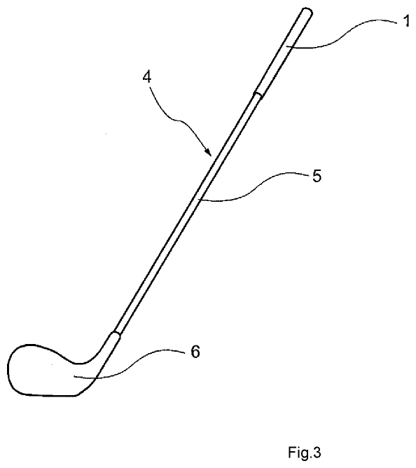

FIG. 3 is a perspective view showing one example of the golf club according to the present invention. A golf club 4 comprises a shaft 5, a head 6 provided on one end of the shaft 5, and a grip 1 provided on another end of the shaft 5. The back end of the shaft 5 is inserted into the cylindrical portion 2 of the grip 1.

### EXAMPLES

Next, the present invention will be described in detail by way of examples. However, the present invention is not limited to the examples described below. Various changes and modifications without departing from the spirit of the present invention are included in the scope of the present invention. [Evaluation method]

### (1) Amount of Acrylonitrile

The amount of the acrylonitrile in the acrylonitrile-butadiene rubber before hydrogenation was measured according to ISO 24698-1 (2008).

### (2) Amount of Double Bond (Mmol/g)

The amount of the double bond was calculated from the amount (mass %) of the butadiene in the copolymer and the amount (%) of the residual double bond. The amount of the residual double bond is a mass ratio (amount of the double bond after hydrogenation/amount of the double bond before hydrogenation) of the double bond in the copolymer after hydrogenation to the double bond in the copolymer before hydrogenation, and can be measured by infrared spectroscopy. When the acrylonitrile-butadiene rubber is the acrylonitrile-butadiene binary copolymer, the amount of the butadiene in the copolymer is calculated by subtracting the amount (mass %) of the acrylonitrile from 100.

Amount of double bond={amount of butadiene/54}×amount of residual double bond×10

### (3) Amount of Monomer Having Carboxy Group

One gram of the hydrogenated acrylonitrile-butadiene rubber was weighed and dissolved in 50 ml of chloroform, and a thymol blue indicator was added therein dropwise. A methanol solution of 0.05 mol/L sodium hydroxide was added dropwise into the solution while the solution was stirred, and the addition amount (V ml) at the time the solution color initially changed was recorded. Regarding a blank, i.e. 50 ml of chloroform not containing the hydrogenated acrylonitrile-butadiene rubber, thymol blue was used as an indicator, a methanol solution of 0.05 mol/L sodium hydroxide was added dropwise into the solution, and the addition amount (B ml) at the time the solution color initially changed was recorded. The amount of the monomer having the carboxy group was calculated according to the following formula.

Amount of monomer having carboxy group={0.05×(V−B)×PM}/(10×X)

(In the formula, V: addition amount (ml) of sodium hydroxide solution in test solution, B: addition amount (ml) of sodium hydroxide solution in blank, PM: molecular weight of monomer having carboxy group, X: valence of monomer having carboxy group)

### (4) Mooney Viscosity (ML₁₊₄ (100° C.))

The Mooney viscosity of the rubber composition was measured according to JIS K6300-1 (2013). The measurement was carried out by using a L-shaped rotor.

### (5) Material Hardness (Shore a Hardness)

Sheets with a thickness of about 2 mm were produced by pressing the rubber composition at a temperature of 160° C. for 8 to 20 minutes. It is noted that when the rubber composition contains the microballoons, the sheets were formed by expanding the microballoons in the same foaming ratio as that when forming the grip. The sheets were stored at a temperature of 23° C. for two weeks. At least three of these sheets were stacked on one another so as not to be affected by the measuring substrate on which the sheets were placed, and the hardness of the stack was measured with an automatic hardness tester (Digitest II, available from Bareiss company) using a testing device of “Shore A”.

### (6) Tensile Strength at Break (Tb)

The tensile strength at break was measured according to JIS K 6251 (2017). Specifically, a sheet with a thickness of 1 mm was formed from the rubber composition and punched into a dumbbell shape (Dumbbell shape No. 3) to prepare a test piece, and properties of the test piece were measured (measuring temperature: 23° C., tensile speed: 500 mm/min) with a tensile tester (Autograph AGS-D available from Shimadzu Corporation). Then, the tensile strength at break was calculated by dividing the tensile force recorded at the time the test piece was broken by the cross-sectional area of the test piece before the test.

### (7) Viscoelastic Properties

The loss tangent (tan δ) and storage modulus (E′) were measured with a dynamic viscoelastic spectrometer (Rheogel-E4000 available from UBM KK). The test sample was prepared by pressing the outer layer rubber composition at a temperature of 160° C. to obtain a rubber plate, and punching the rubber plate into a determined size. The measurement was performed under conditions of a temperature range: −100° C. to 100° C., a temperature rising rate: 3° C./min, a measuring interval: 3° C., a frequency: 10 Hz, a strain amplitude: 0.05%, a jig: tensile mode, and a sample shape: width of 4 m, thickness of 1 mm and length of 40 mm. The E′ at 23° C., and the tan δ and E′ at 60° C. were calculated from the viscoelastic spectrum obtained by the dynamic viscoelastic measurement.

### (8) Shrinking Rate

A calender roll was used to press the outer layer rubber composition into a sheet with a thickness of 0.80 mm. The thickness (D1) of the rubber sheet immediately after the pressing and the thickness (D2) of the rubber sheet one week later after the pressing were measured, and the following formula was used to calculate the shrinking rate. In addition, the surface of the rubber sheet one week later after the pressing was visually observed, the case that there is no obvious unevenness was evaluated as “G (Good)”, the case that unevenness occurs but lamination with the inner layer is possible was evaluated as “F (Fair)”, and the case that unevenness occurs and lamination with the inner layer is difficult was evaluated as “P (Poor)”.

Shrinking rate (%)={(D2−D1)/D1}×100

### (9) Evaluation of Grip Appearance

The appearance of the prepared grips was visually observed, and evaluated by the following standard.

G (Good): No swelling of the outer layer caused by air bubbles was observed immediately after the grip was ejected from the mold.

F (Fair): Swelling of the outer layer was observed in appearance immediately after the grip was ejected from the mold, but the swelling of the outer layer was not observed after the grip was cooled.

P (Poor): Swelling of the outer layer was observed in appearance immediately after the grip was ejected from the mold and after the grip was cooled.

### [Production of Grip]

According to the formulations shown in Tables 1 and 2, the materials were kneaded to prepare the outer layer rubber compositions and the inner layer rubber compositions. It is noted that, the outer layer rubber compositions were prepared by kneading all the materials with a Banbury mixer, and the inner layer rubber compositions were prepared by kneading the materials except the microballoons with a Banbury mixer followed by blending the microballoons therein with a roll. The material temperature when kneading the inner layer rubber compositions with the Banbury mixer and the material temperature when blending the microballoons with the roll is lower than the expansion starting temperature of the microballoons.

TABLE 1

| Outer layer rubber composition No. | | | A | B | C | D | E | F | G |
|---|---|---|---|---|---|---|---|---|---|
| Formulation | Base rubber | HXNBR | 100 | 100 | 100 | 100 | 100 | 100 | 100 |
| (parts by | Tackifier | EVA | 8 | 20 | 30 | 8 | 8 | 20 | — |
| mass) | | Sylvatac RE 5S | 8 | 8 | 8 | 8 | 8 | 8 | 8 |
| | Reinforcing | SEAST 3 | 5 | 5 | 5 | 15 | 30 | 10 | 5 |
| | material | | | | | | | | |
| | Vulcanization | Zinc peroxide | 5 | 5 | 5 | 5 | 5 | 5 | 5 |
| | activator | | | | | | | | |
| | Crosslinking | Sulfur | 1.5 | 1.5 | 1.5 | 1.5 | 1.5 | 1.5 | 1.5 |
| | agent | | | | | | | | |
| | Vulcanization | SANCELER | 3 | 3 | 3 | 3 | 3 | 3 | 3 |
| | | TBzTD | | | | | | | |
| | accelerator | NOCCELER | 3 | 3 | 3 | 3 | 3 | 3 | 3 |
| | | TOT-N | | | | | | | |
| | | NOCCELER EUR | 1 | 1 | 1 | 1 | 1 | 1 | 1 |

| | | | | | | | | |
|---|---|---|---|---|---|---|---|---|
| Properties | Mooney viscosity (100° C.) | 53.1 | 52.1 | 41.4 | 61.7 | 70.2 | 54.3 | 49.0 |

TABLE 2

| Inner layer rubber composition No. | | | a |
|---|---|---|---|
| Formulation | Base rubber | HNBR | 100 |
| (parts by mass) | Tackifier | Sylvatac RE 5S | 10 |
| | Reinforcing material | SEAST 3 | 5 |
| | Vulcanization activator | Zinc oxide | 3 |
| | Crosslinking agent | Sulfur | 1.5 |
| | Vulcanization accelerator | NOCCELER TOT-N | 1.5 |
| | Foaming agent | Microballoons | 10 |

The materials used in Tables 1 and 2 are shown as follows.

HXNBR: hydrogenated carboxy-modified acrylonitrile-butadiene rubber (Therban XT VPKA 8889 (amount of residual double bond: 3.5%, amount of acrylonitrile: 33.0 mass %, amount of double bond: 0.40 mmol/g, amount of monomer having carboxy group: 5.0 mass %, Mooney viscosity (ML₁₊₄ (100° C.)): 77) available from ARANXEO Corporation)

HNBR: hydrogenated acrylonitrile-butadiene rubber (Therban 3446 (amount of residual double bond: 4.0%, amount of acrylonitrile: 34.0 mass %) available from ARANXEO Corporation)

EVA: ethylene-vinyl acetate copolymer (Levapren 500 (amount of vinyl acetate: 50 mass %, Mooney viscosity (ML₁₊₄ (100° C.)): 27) available from ARANXEO Corporation)

Sylvatac RE 5S: rosin ester available from Arizona Chemical Corporation

SEAST (registered trademark) 3: carbon black available from Tokai Carbon Co., Ltd.

Zinc peroxide: Struktol ZP 1014 (amount of zinc peroxide: 29 mass %) available from Struktol Corporation

Zinc oxide: WHITE SHEEL available from PT. INDO LYSAGHT

Sulfur: 5% oil treated sulfur fine powder (200 mesh) available from Tsurumi Chemical Industry Co., Ltd.

SANCELER (registered trademark) TBzTD: tetrabenzylthiuram disulfide available from Sanshin Chemical Industry Co., Ltd.

NOCCELER (registered trademark) TOT-N: tetrakis(2-ethylhexyl)thiuram disulfide available from Ouchi Shinko Chemical Industrial Co., Ltd.

NOCCELER EUR: N,N′-diethyl thiourea available from Ouchi Shinko Chemical Industrial Co., Ltd.

Microballoons: “Expancel (registered trademark) 909-80DU” (resin capsule encapsulating a hydrocarbon having a low boiling point in a shell formed from a thermoplastic resin, volume average particle size: 18 μm to 24 μm, expansion starting temperature: 120° C. to 130° C.) available from Akzo Nobel Company

The unvulcanized rubber sheet having a fan shape and the cap member were prepared using the outer layer rubber composition. It is noted that the outer layer rubber sheet was formed with a fixed thickness. The unvulcanized rubber sheet having a rectangular shape was prepared using the inner layer rubber composition. It is noted that the inner layer rubber sheet was formed with a thickness gradually becoming thicker from one end toward another end. The inner layer rubber sheet was wound around a mandrel, and then the outer layer rubber sheet was laminated and wound around the inner layer rubber sheet. The mandrel wound with these rubber sheets, and the cap member were charged into a mold having a groove pattern on the cavity surface thereof. A heat treatment was performed at a mold temperature of 160° C. for 15 minutes to obtain golf club grips. In the obtained golf club grips, the cylindrical portion had a thickness of 1.5 mm at the thinnest part (the end on the head side), and a thickness of 6.7 mm at the thickest part (the end on the grip end side). In addition, the surface of the obtained grips was buffed with an abrasive paper (#80).

TABLE 3

| Grip No. | | 1 | 2 | 3 | 4 | 5 | 6 | 7 |
|---|---|---|---|---|---|---|---|---|
| Inner | Rubber | a | a | a | a | a | a | a |
| layer | composition No. | | | | | | | |
| | Material hardness | 39 | 39 | 39 | 39 | 39 | 39 | 39 |
| | (Shore A) | | | | | | | |
| | Type | Foamed | Foamed | Foamed | Foamed | Foamed | Foamed | Foamed |
| | Foaming ratio | 3.3 | 3.3 | 3.3 | 3.3 | 3.3 | 3.3 | 3.3 |
| Outer | Rubber | B | C | F | A | D | E | G |
| layer | composition No. | | | | | | | |
| | Material hardness | 46 | 42 | 44 | 43 | 49 | 54 | 37 |
| | (Shore A) | | | | | | | |
| | Type | Solid | Solid | Solid | Solid | Solid | Solid | Solid |
| | Thickness (mm) | 0.8 | 0.8 | 0.8 | 0.8 | 0.8 | 0.8 | 0.8 |
| Properties | Tensile strength at | 28.3 | 23.4 | 27.0 | 34.5 | 38.2 | 39.8 | 24.5 |
| of outer | break (MPa) | | | | | | | |
| layer | tan δ (60° C.) | 0.138 | 0.153 | 0.139 | 0.120 | 0.127 | 0.143 | 0.104 |
| | E′ (60° C.) (MPa) | 2.64 | 2.50 | 3.04 | 2.79 | 3.75 | 5.85 | 3.78 |
| | E′ (23° C.) (MPa) | 3.20 | 3.18 | 3.93 | 3.20 | 4.45 | 7.81 | 4.21 |
| | E′ (23° C.)/ | 1.21 | 1.27 | 1.29 | 1.15 | 1.19 | 1.33 | 1.11 |
| | E′ (60° C.) | | | | | | | |
| Shrinking | Shrinking rate (%) | 28.1 | 14.1 | 23.6 | 36.5 | 34.7 | 32.7 | 34.0 |
| evaluation | Surface state | G | G | G | P | P | F | P |

| | | | | | | | |
|---|---|---|---|---|---|---|---|
| Evaluation of grip appearance | G | G | G | P | P | F | P |

The grips No. 1 to 3 are the cases that the outer layer has the ratio (E′₂₃/E′₆₀) ranging from 1.20 to 1.32. These grips had a low shrinking rate in the outer layer material, and no swelling of the outer layer caused by entrainment of air existed in these prepared grips.

This application is based on Japanese patent application No. 2021-093015 filed on Jun. 2, 2021, the content of which is hereby incorporated by reference.

1. A golf club grip comprising a cylindrical portion composed of a cylindrical inner layer and a cylindrical outer layer covering the inner layer, wherein a ratio (E′₂₃/E′₆₀) of a storage modulus (E′₂₃) at the temperature of 23° C. of the outer layer to a storage modulus (E′₆₀) at the temperature of 60° C. of the outer layer, measured with a dynamic viscoelasticity measuring apparatus under measuring conditions of an oscillation frequency: 10 Hz, a strain amplitude: 0.05%, and a tensile mode, ranges from 1.20 to 1.32.

2. The golf club grip according to claim 1, wherein the outer layer has a tensile strength at break ranging from 20 MPa to 30 MPa.

3. The golf club grip according to claim 1, wherein a rubber composition forming the outer layer has a Mooney viscosity (ML₁₊₄ (100° C.)) ranging from 35 to 55.

4. The golf club grip according to claim 1, wherein the outer layer has a loss tangent (tan δ) at the temperature of 60° C. of 0.138 or more, measured with a dynamic viscoelasticity measuring apparatus under measuring conditions of an oscillation frequency: 10 Hz, a strain amplitude: 0.05%, and a tensile mode.

5. The golf club grip according to claim 1, wherein the outer layer contains at least one member selected from the group consisting of a carboxy-modified acrylonitrile-butadiene rubber, a hydrogenated acrylonitrile-butadiene rubber, and a carboxy-modified hydrogenated acrylonitrile-butadiene rubber.

6. The golf club grip according to claim 1, wherein the storage modulus (E′₂₃) ranges from 2.0 MPa to 4.2 MPa.

7. The golf club grip according to claim 1, wherein the storage modulus (E′₆₀) ranges from 1.5 MPa to 3.7 MPa.

8. The golf club grip according to claim 1, wherein a rubber composition forming the outer layer has a material hardness ranging from 25 to 60 in Shore A hardness.

9. The golf club grip according to claim 1, wherein a rubber composition forming the outer layer contains (A) a base rubber, (B) a thermoplastic resin, and (C) a crosslinking agent.

10. The golf club grip according to claim 9, wherein (A) the base rubber includes an acrylonitrile-butadiene based rubber.

11. The golf club grip according to claim 9, wherein (B) the thermoplastic resin includes (B1) an ethylene-vinyl acetate copolymer and (B2) a rosin ester.

12. The golf club grip according to claim 9, wherein (B) the thermoplastic resin is contained in an amount ranging from 5 parts by mass to 45 parts by mass with respect to 100 parts by mass of (A) the base rubber.

13. The golf club grip according to claim 11, wherein (B1) the ethylene-vinyl acetate copolymer is contained in an amount ranging from 3 parts by mass to 40 parts by mass with respect to 100 parts by mass of (A) the base rubber.

14. The golf club grip according to claim 11, wherein (B2) the rosin ester is contained in an amount ranging from 2 parts by mass to 15 parts by mass with respect to 100 parts by mass of (A) the base rubber.

15. The golf club grip according to claim 11, wherein a mass ratio (B1/B2) of (B1) the ethylene-vinyl acetate copolymer to (B2) the rosin ester ranges from 0.8 to 5.0.

16. The golf club grip according to claim 9, wherein (C) the crosslinking agent includes an elemental sulfur.

17. The golf club grip according to claim 16, wherein (C) the crosslinking agent is contained in an amount ranging from 0.2 part by mass to 4.0 parts by mass with respect to 100 parts by mass of (A) the base rubber.

18. The golf club grip according to claim 9, wherein the rubber composition forming the outer layer further contains a vulcanization accelerator or a vulcanization activator.
